(19) United States
(12) Patent Application Publication
(10) Pub. No.: US 2013/0271327 A1
(43) Pub. Date: Oct. 17, 2013

(54) WIRELESS DEVICE

(71) Applicant: DENSO CORPORATION, Aichi-Pref. (JP)

(72) Inventor: Katsuhiro OOHARA, Nagoya-city (JP)

(73) Assignee: DENSO CORPORATION, Aichi-Pref. (JP)

(21) Appl. No.: 13/792,981

(22) Filed: Mar. 11, 2013

(30) Foreign Application Priority Data
Apr. 11, 2012 (JP) 2012-90143

(51) Int. Cl. H01Q 1/24

(52) U.S. Cl. CPC H01Q 1/24
USPC 343/702

(57) ABSTRACT

A circuit board is interposed between a lower casing and an upper casing. A screw member is inserted through a screw hole of the upper casing and a through-hole formed in the circuit board and firmly fixed to the lower casing. An electrostatic coupling member is arranged between an outer surface of the screw member and an inner peripheral surface of the through-hole. The electrostatic coupling member is connected to an electric circuit formed on the circuit board via a power-supply line. The screw member is electrically, without physical contact, coupled to the electrostatic coupling member in an equivalent circuit having a capacitor.

### CROSS REFERENCE TO RELATED APPLICATION

This application is based on Japanese Patent Application No. 2012-090143 filed on Apr. 11, 2012, the disclosure of which is incorporated herein by reference.

### FIELD OF TECHNOLOGY

The present disclosure relates to a wireless device for carrying out wireless communication,

### BACKGROUND

A wireless device is known in the art, for example, as disclosed in Japanese Patent Publication No. 2003-298328 or Japanese Patent Publication No. 2005-3281112. According to the wireless device of such prior arts, a power-supply line connected to an antenna is physically connected to a screw member, which mechanically fixes several parts for the wireless device to each other, so that the screw member functions as the antenna.

In the above wireless device, however, since the screw member is physically connected to the power-supply line, contact resistance may be changed as a result of looseness of the screw member due to vibration or corrosion of the screw member due to moisture content when the wireless device is used in a had condition. It is, therefore, a problem that characteristic features of the antenna (for example, resonance frequency, gain or the like) may be changed.

### SUMMARY OF THE DISCLOSURE

The present disclosure is made in view of the above point. It is an object of the present disclosure to provide a wireless device, in which a screw member is used as an antenna but the characteristic features of the antenna are not changed even when the wireless device is used in a bad condition.

According to a feature of the present disclosure, a wireless device has a screw member and an electrostatic coupling member. The screw member is made of material being able to transmit and/or receive signals as an antenna and the screw member fixes an electric component to a casing. The electrostatic coupling member is arranged at a position close to an outer surface of the screw member, when the electric Component is fixed to the casing by the screw member. The electrostatic coupling member electrically connects the screw member to a power-supply line in an electrostatic coupling manner.

According to the above feature, it is not necessary to physically make contact the screw member and the power-supply line with each other. The screw member is electrically connected to the power-supply line in a condition that a capacitor is provided between them. As a result, a change of contact resistance, which may be caused by looseness of the screw member due to vibration or corrosion of the screw member due to moisture content when the wireless device is used in a bad condition, can be prevented. it is, therefore, possible to suppress a change of characteristic features of the antenna (for example, resonance frequency, gain or the like)

The electrostatic coupling member can be arranged at any position, which is close to the outer surface of the screw member. An actual position of the electrostatic coupling member should not be limited to a position explained hereinafter in relation to embodiments.

However, the electrostatic: coupling member may be preferably arranged at a certain position, in order to effectively bring out a function of the antenna.

For example, according to another feature of the present disclosure, the electrostatic coupling member is preferably arranged at a position, which is separate in a longitudinal direction of the screw member from one end of the screw member by such “a distance corresponding to a wavelength of the signals to be transmitted and/or received as the antenna”.

According to such a feature, a portion of the screw member, which belongs to an area from the one end of the screw member to the position of the electrostatic coupling member in a longitudinal direction of the screw member, can properly function as the antenna for desired signals.

“The distance corresponding to the wavelength of the signals to be transmitted and/or received as the antenna” is, for example, a half or a quarter of the wavelength of the signals which is supposed to be transmitted and/or received by the wireless device.

In addition, according to a further feature of the present disclosure, a length of the screw member in the longitudinal direction thereof from the position of the electrostatic coupling member to the other end of the screw member corresponds to such a value that an impedance of the screw member as the antenna fits together with an impedance of an electric circuit, to which the screw member is electrically connected.

According to the above feature, the length of the portion of the screw member between the electrostatic coupling member and the other end of the screw member is so decided that the impedance of the screw member as the antenna fits together with the impedance of the electric circuit, to which the screw member is electrically connected.

According to the above structure, the other end of the screw member, that is, the antenna, can function as an open stub, so that the impedance of the screw member as the antenna can be fitted together with the impedance of the electric circuit, to which the screw member is electrically connected.

An actual structure for fixing the electric component to the casing should not be limited to a structure explained hereinafter in relation to the embodiments.

However, as one of preferable structures, a through-hole is formed in the electric component (for example, an electric circuit board) in its thickness direction, the electric circuit board is interposed between a lower and an upper casings of the casing, and a forward end of the screw member is inserted through the through-hole so as to fix the electric circuit board to the casing. And the electrostatic coupling member is arranged at an inner peripheral surface of the through-hole formed in the electric circuit board.

According to the above feature, it is not necessary to independently provide the power-supply line but the power-supply line can be integrally formed with the circuit board. In addition, since the electrostatic coupling member is provided at the inner surface of the through-hole, through which the screw member passes, the power-supply line is electrically connected to the screw member at the same time when the circuit board is fixed to the casing by the screw member.

According to a still further feature of the present disclosure, a head portion is formed either at the one end or at the other end of the screw member, wherein an outer diameter of the head portion is larger than that of the remaining portion of the screw member.

According to the above feature, a length of the antenna can be made smaller by an amount corresponding to the outer diameter of the head portion or the wavelength of the signals supposed to be transmitted or received, when compared with a case in which no head portion is formed.

It is not always necessary to provide any member between the outer surface of the screw member and the electrostatic coupling member. However, according to a still further feature of the present disclosure, a dielectric member made of dielectric material is provided between the outer surface of the screw member and the electrostatic coupling member.

According to the above feature, the performance of the capacitor is ensured by the dielectric member. In addition, the dielectric member prevents a distance between the screw member and the electrostatic coupling member from being changed by any disturbance.

The wireless device of the present disclosure can be, in particular, effectively used for the vehicle as a part of an electronic device installed in the vehicle, wherein the wireless device is exposed to lots of vibrations.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a schematic cross sectional view showing a relevant portion of a wireless device according to an embodiment of the present disclosure;

FIG. 1B is an enlarged perspective view showing an electrostatic coupling member and a dielectric member;

FIG. 2 is a schematic cross sectional view showing a relevant portion of a wireless device according to a modification of the embodiment of the present disclosure; and

FIGS. 3A and 3B are schematic cross sectional views, each showing a relevant portion of a wireless device of further modifications of the embodiment of the present disclosure.

### DETAILED DESCRIPTION OF THE EMBODIMENTS

A wireless device of the present disclosure will be explained by way of multiple examples and/or modifications with reference to drawings. The same reference numerals are given to the same or similar parts and/or portions throughout the embodiments and/or modifications so as to omit repeated explanation.

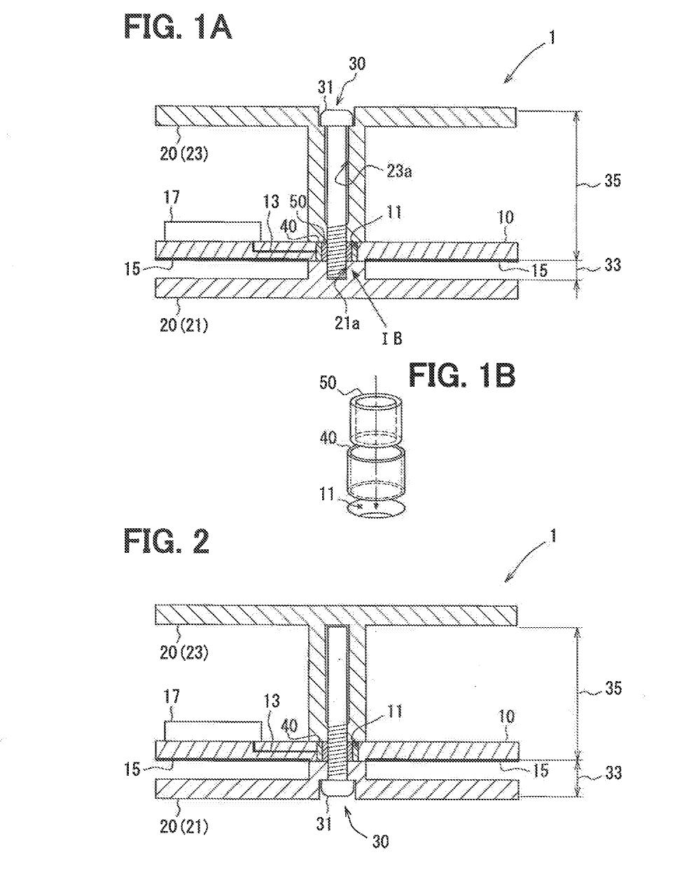

The wireless device 1 of the present disclosure is used as a portion of an electric or electronic device installed in a vehicle. As shown in FIGS. 1A and 15, the wireless device 1 has an electric circuit board 10 (hereinafter, the circuit board 10), a screw member 30 for fixing the circuit board 10 to a casing 20, and an electrostatic coupling member 40 arranged at an outer surface of the screw member 30 and positioned close to the outer surface of the screw member 30. The circuit board 10 is also referred to as an electric component.

In the present embodiment, the circuit board 10 is interposed between a lower casing 21 and an upper casing 23 of the casing 20. A through-hole 11 is formed in the circuit board 10. A portion of the circuit board 10 surrounding the through-hole 11 is sandwiched between the lower and the upper casings 21 and 23. A forward end of the screw member 30 is inserted through a screw hole 23a of the upper casing 23 and the trough-hole 11 of the circuit board 10 and screwed into a screw hole 21a of the lower casing 21, so as to fix the circuit board 10 to the casing 20.

A head portion 31 is formed at an upper end of the screw member 30. An outer diameter of the head portion 31 is larger than that of the remaining body portion of the screw member 30. The screw member 30 is made of such material (for example, conductive material such as metal), so that the screw member 30 transmits and receives signals as an antenna. The screw member 30 is electrically coupled to a power-supply line 13 formed in the circuit board 10 so as to function as the antenna.

The forward end of the screw member 30 projects in a downward direction from a position of the electrostatic coupling member 40 (more exactly, projects from a ground 15 formed on a bottom surface of the circuit board 10). The ground 15 is a reference surface. A portion of the screw member 30, which. projects in the downward direction from the reference surface (that is, the ground 15), is referred to as a lower portion 33 of the screw member 30. In the present embodiment, the lower portion 33 of the screw member 30 functions as an open stub, so that an impedance of the antenna fits together with an impedance of an electric circuit 17 of the circuit board 10, to which the screw member 10 is electrically coupled. In the present embodiment, a length of the lower portion 33 is adjusted, so that the impedance which is defined by the length of the lower portion 33 and a wavelength of the signals fits together with the impedance of the electric circuit 17, to which the screw member 10 is electrically coupled.

The electrostatic coupling member 40, which is formed in a ring shape, is an electrode terminal for electrically coupling the power-supply line 13 to the screw member 30. In an assembled condition (in a condition that the circuit board 10 is fixed to the casing 20 by the screw member 30), as shown in FIG. 1A, the electrostatic coupling member 40 is arranged at the outer surface of the screw member 30 and positioned close to the outer surface thereof. In the position of the electrostatic member 40 shown in FIG. 1A, the screw member 30 and the power-supply line 13 are electrically coupled with each other by the electrostatic coupling member 40 in an electrostatic coupling manner,

The electrostatic coupling member 40 is arranged at such a position, which is separate in a longitudinal direction of the screw member 30 from an upper end of the screw member 30 by a distance corresponding to a wavelength of the signals to be transmitted and received as the antenna. More exactly, a portion of the screw member 30 from the reference surface (that is, the ground 15 formed on the bottom surface of the circuit board 10) to the upper end of the screw member 30 is referred to as an upper portion 35 of the screw member 30. Therefore, a length of the upper portion 35 of the screw member 30 corresponds to the wavelength of the signals.

In the present embodiment, the position of the through-hole 11 of the circuit board 10 corresponds to such a position, which defines the length of the upper portion 35 of the screw member 30, so that the length of the upper portion 35 corresponds to the wavelength of the signals to be transmitted and received. Therefore, when the electrostatic coupling member 40 is arranged at an inner peripheral surface of the through-hole 11 so as to surround the screw member 30, the electrostatic coupling member 40 is arranged at the position, which realizes that the length of the upper portion 35 of the screw member 30 corresponds to the wavelength of the signals to be transmitted and received.

“The length corresponding to the wavelength of the signals to be transmitted and received as the antenna” is, for example, a half or a quarter of the wavelength of the signals which is supposed to be transmitted and/or received by the wireless device 1.

When the outer diameter of the head portion 31 of the screw member 30 is made larger, “the length corresponding to the wavelength of the signals to be transmitted and received as the antenna” can be made shorter. In the present embodiment, the outer diameter of the head portion 31 is designed to be a small value, so that the outer diameter of the head portion 31 does not largely influence on deciding the whole length of the screw member 30 in view of the wavelength of the signals. As a result, “the length corresponding to the wavelength of the signals to be transmitted and received as the antenna” becomes equal to the half or the quarter of the wavelength of the signals.

A dielectric member 50 made of dielectric material is provided between the outer surface of the screw member 30 and an inner surface of the electrostatic coupling member 40.

According to the above structure of the wireless device 1, the screw member 30 and the electrostatic coupling member 40 are in a condition equal to an electric circuit, in which the screw member 30 and the electrostatic coupling member 40 are electrically coupled to each other via a capacitor. For example, in a case that the length of the upper portion 35 of the screw member 30 is the quarter of the wavelength, a thickness of the circuit board 10 is 3 mm, and a diameter of the through-hole 11 formed in the circuit board 10 is 2 mm, the screw member 30 and the electrostatic coupling member 40 are coupled to each other in an equivalent circuit having the capacitor of about 1 pF between them.

According to the wireless device 1 of the present embodiment, it is possible to electrically couple the screw member 30 and the power-supply line 13 via the capacitor, without physically contacting the screw member 30 and the power-supply line 13 with each other. According to the above structure, the contact resistance may not be changed as a result of looseness of the screw member 30 due to the vibration or corrosion of the screw member 30 due to moisture content, when the wireless device 1 is used in a bad condition. It is, therefore, possible to avoid a situation that characteristic features of the antenna (for example, resonance frequency, gain or the like) may be changed.

In particular, the present embodiment is effectively applied to the wireless device 1, which is used as a part of the electronic device installed in the vehicle, wherein the wireless device 1 is exposed to vibrations.

In the present embodiment, the electrostatic coupling member 40 is arranged at the position, which is separate in the longitudinal direction of the screw member 30 from the upper end of the screw member 30 by the distance (or the length) corresponding to the wavelength of the signals to be transmitted or received as the antenna. The portion of the screw member 30, which belongs to an area extending in the longitudinal direction from the upper end of the screw member 30 to the position for the electrostatic coupling member 40, namely, the upper portion 35 of the screw member 30 can properly function as the antenna for the predetermined signals.

The lower portion 33 of the screw member 30 functions as the open stub. As a result, the impedance of the screw member 30 as the antenna can be fitted together with the impedance of the electric circuit 17, to which the antenna (the screw member 30) is electrically connected.

In the present embodiment, it is not necessary to provide an independent power line for the power-supply line 13 electrically coupled to the screw member 30 working as the antenna. Namely, the power-supply line 13 can be integrally formed with the circuit board 10. In addition, since the electrostatic coupling member 40 is provided at the inner peripheral surface of the through-hole 11, through which the screw member 30 passes, the power-supply line 13 is electrically connected to the screw member 30 at the same time when the circuit board 10 is fixed to the casing 20 by the screw member 30.

In addition, the dielectric member SO, which is formed in a ring shape and made of the dielectric material (FIG. 1B), is provided between the outer surface of the screw member 30 and the electrostatic coupling member 40. The electrical coupling is formed between the screw member 30 and the electrostatic coupling member 40 via the capacitor. The performance of the capacitor is ensured by the dielectric member 50. In addition, the dielectric member 50 prevents a distance (a gap) between the screw member 30 and the electrostatic coupling member 40 from being changed by any disturbance.

The present disclosure should not be limited to the above embodiment but can be modified in various manners without departing from the spirit of the present disclosure.

In the above embodiment, the outer diameter of the head portion 31 of the screw member 30 is made so small as not to notably give the influence to the transmission and/or the receipt of the signals. However, the outer diameter of the head portion 31 may be made larger, so that the influence to the transmission and/or the receipt of the signals may become obvious. In such a case, the length of the screw member 30 (that is, the length of the antenna) is made shorter by an amount corresponding to the outer diameter of the head portion 31 and the wavelength of the signals supposed to be transmitted and/or received.

In the above embodiment, the head portion 31 is provided. at the upper end of the screw member 30. However, as shown in FIG. 2, the screw member 30 may be inserted through the screw hole 21a formed in the lower casing 21 in the upward direction. The screw member 30 passes through the through-hole 11 of the circuit board 10 and screwed into the upper casing 23, Accordingly, the head portion 31 may be formed at the lower end of the screw member 30.

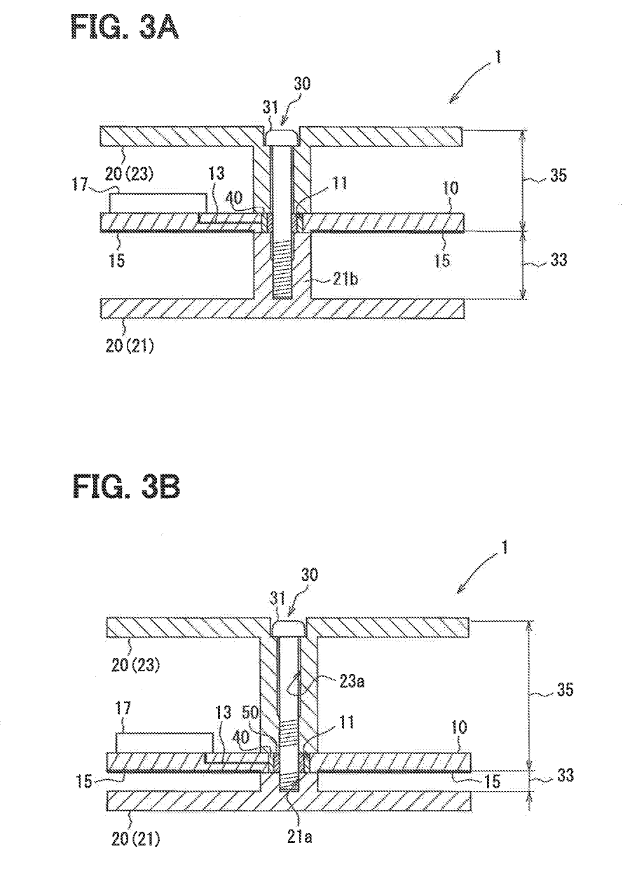

In the above embodiment or the modification, a screw-thread portion of the screw member 30 is formed in an area surrounded by the through-hole 11, that is, an area surrounded by the electrostatic coupling member 40. However, a height of a screw-fitting portion 21b of the lower casing 21 may be made larger, as shown in FIG. 3A, so that the screw-thread portion of the screw member 30 is completely accommodated in the screw-fitting portion 21b. In other words, a portion of the screw member 30, at which no screw thread is formed, is positioned in the area surrounded by the through-hole 11 as well as the electrostatic coupling member 40. Alternatively, as shown in FIGS. 3B, a portion of the screw member 30, at which no screw thread is formed, is formed between the screw-thread portions, so that the portion of the screw member 30 having no screw thread is positioned in the area surrounded by the through-hole 11 as well as the electrostatic coupling member 40. According to the structures of the above modifications (FIGS. 3A and 3B), the characteristic features of the capacitor (electrostatic capacitance, etc.) can be more precisely defined.

In the above embodiments and/or modifications, the dielectric member 50 is provided between the outer surface of the screw member 30 and the electrostatic coupling member 40. It is not always necessary to provide the dielectric member 50. Only an air layer may be formed between the outer surface of the screw member 30 and the electrostatic coupling member 40. In such a case, the distance (the gap) between the outer surface of the screw member 30 and the electrostatic coupling member 40 can be made smaller in view of the dielectric constant, in order to bring out the function of the capacitor having the same characteristic feature to that of the case having the dielectric member 50.

What is claimed is:

1. A wireless device comprising:
a screw member made of material being able to transmit and/or receive signals as an antenna, the screw member fixing an electric component to a casing; and
an electrostatic coupling member arranged at a position close to an outer surface of the screw member when the electric component is fixed to the casing by the screw member,
wherein the electrostatic coupling member electrically connecting the screw member to a power-supply line in an electrostatic coupling manner.

2. The wireless device according to claim 1, wherein
the electrostatic coupling member is arranged at a position, which is separate in a longitudinal direction of the screw member from one end of the screw member by such a distance corresponding to a wavelength of the signals to be transmitted and/or received as the antenna.

3. The wireless device according to claim 2, wherein
a length of the screw member in the longitudinal direction thereof from the position of the electrostatic coupling member to the other end of the screw member corresponds to such a value that an impedance of the screw member as the antenna fits together with an impedance of an electric circuit, to which the screw member is electrically connected.

4. The wireless device according to claim 1, wherein
the casing is composed of a lower casing and an upper casing,
the electric component is composed of an electric circuit board,
the electric circuit board is interposed between the lower and the upper casings,
a through-hole is formed in the electric circuit board in its thickness direction,
a forward end of the screw member is inserted through the through-hole so as to fix the electric circuit board to the casing, and
the electrostatic coupling member is arranged at an inner peripheral surface of the through-hole formed in the electric circuit board.

5. The wireless device according to claim 1, wherein
a head portion is formed either at the one end or at the other end of the screw member, wherein an outer diameter of the head portion is larger than that of the remaining portion of the screw member.

6. The wireless device according to claim 1, wherein
a dielectric member made of dielectric material is provided between the outer surface of the screw member and the electrostatic coupling member.

7. The wireless device according to claim 1, wherein
the wireless device is used as a part of an electronic device installed in a vehicle.

8. The wireless device according to claim 1, wherein
a screw-thread portion is formed at the forward end of the screw member, except for such an area of the screw member surrounded by the electrostatic coupling member.

9. The wireless device according to claim 6, wherein
each of the electrostatic coupling member and the dielectric member is formed in a ring shape and coaxially arranged with the screw member.

10. The wireless device according to claim 4, wherein
the power-supply line is integrally formed in the electric circuit board.
